(19) United States
(12) Patent Application Publication
(10) Pub. No.: US 2005/0243706 A1
(43) Pub. Date: Nov. 3, 2005

(54) Rewritable optical data storage medium and use of such a medium

(75) Inventors: Martijn Henri Richard Lankhorst, Eindhoven (NL); Liesbeth Van Pieterson, Eindhoven (NL); Mark Van Schijndel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/519,067

(22) PCT Filed: Jun. 13, 2003
(86) PCT No.: PCT/IB03/02930

§ 371 Date: Dec. 22, 2004

(30) Foreign Application Priority Data
Jul. 4, 2002 (EP) 02077656.3

(51) Int. Cl. G11B 7/26

(52) U.S. Cl. 369/288; 369/275.2

(57) ABSTRACT

A rewritable optical data storage medium (20) for high-speed recording by means of a focused radiation beam (10) is described. The medium (20) comprises a substrate (1) carrying a stack (2) of layers. The stack (2) comprises a first dielectric layer (3), a second dielectric layer (5), and a recording layer (4) of a phase-change material of an alloy comprising Sb and Te. The recording layer (4) is interposed between the first dielectric layer (3) and the second dielectric layer (5). The alloy additionally contains 2-10 at. % of Ga, by which a significant improvement of the maximum data rate during direct overwrite is achieved. By furthermore adding 0.5-4.0% of Ge to the alloy the archival life stability is enhanced.

The invention relates to a rewritable optical data storage medium for high-speed recording by means of a focused radiation beam, said medium comprising a substrate carrying a stack of layers, which stack comprises, a first dielectric layer, a second dielectric layer, and a recording layer of a phase-change material of an alloy comprising Sb and Te, the recording layer being interposed between the first dielectric layer and the second dielectric layer.

The invention also relates to the use of such an optical data storage medium in high data rate applications.

An embodiment of an optical data storage medium of the type mentioned in the opening paragraph is known from United States patent U.S. Pat. No. 6,108,295.

An optical data storage medium based on the phase change principle is attractive, because it combines the possibilities of direct overwrite (DOW) and high storage density with easy compatibility with read-only optical data storage systems. Phase-change optical recording involves the formation of submicrometer-sized amorphous recording marks in a crystalline recording layer using a focused relatively high power radiation beam, e.g. a laser-light beam. During recording of information, the medium is moved with respect to the focused laser-light beam that is modulated in accordance with the information to be recorded. Marks are formed when the high power laser-light beam melts the crystalline recording layer. When the laser-light beam is switched off and/or subsequently moved relatively to the recording layer, quenching of the molten marks takes place in the recording layer, leaving an amorphous information mark in the exposed areas of the recording layer that remains crystalline in the unexposed areas. Erasure of written amorphous marks is realized by recrystallization through heating with the same laser at a lower power level, without melting the recording layer. The amorphous marks represent the data bits, which can be read, e.g. via the substrate, by a relatively low-power focused laser-light beam. Reflection differences of the amorphous marks with respect to the crystalline recording layer bring about a modulated laser-light beam which is subsequently converted by a detector into a modulated photocurrent in accordance with the recorded information.

One of the most important demands in phase-change optical recording is a high data rate, which means that data can be written and rewritten in the medium with a user data rate of at least 30 Mbits/s. Such a high data rate requires the recording layer to have a high crystallization speed, i.e. a short crystallization time, during DOW. To ensure that previously recorded amorphous marks can be recrystallized during DOW, the recording layer must have a proper crystallization speed to match the velocity of the medium relative to the laser-light beam. If the crystallization speed is not high enough the amorphous marks from the previous recording, representing old data, cannot be completely erased, meaning recrystallized, during DOW. This causes a high noise level. A high crystallization speed is particularly required in high-density recording and high data rate optical recording media, such as in disk-shaped CD-RW high speed, DVD−RW, DVD+RW, DVD-RAM, DVR-red and blue which are abbreviations of a new generation high density Digital Versatile Disk+RW, where RW refers to the rewritability of such disks, and Digital Video Recording optical storage disks, where red and blue refer to the used laser wavelength. The blue version is also called Blu-ray Disk (BD). For these disks the complete erasure time (CET) has to be lower than 30 ns. CET is defined as the minimum duration of an erasing pulse for complete crystallization of a written amorphous mark in a crystalline environment, which is measured statically. For DVD+RW, which has a 4.7 GB recording density per 120 mm disk, a user data bit rate of 26 Mbits/s is needed, and for DVR-blue said rate is 35 Mbits/s. For high speed versions of DVD+RW and DVR-blue data rates of 50 Mbits/s and higher are required. For complete erasure of an amorphous mark, two processes are known, i.e. crystallization by nucleation and crystallization by grain crystallite growth. Nucleation of crystallites is a process where nuclei of crystallites are spontaneously and randomly formed in the amorphous material. Therefore the probability of nucleation depends on the volume, e.g. thickness, of the recording material layer. Grain growth crystallization may occur when crystallites are already present, e.g. the crystalline surroundings of an amorphous mark or crystallites which have been formed by nucleation. Grain growth involves the growth of those crystallites by crystallization of amorphous material adjacent the already present crystallites. In practice both mechanisms may occur in parallel but generally one mechanism dominates over the other in terms of efficiency or speed.

Another very important demand in phase-change optical recording is a high data stability, which means that recorded data remain intact for a long period of time. A high data stability requires the recording layer to have a low crystallization rate, i.e. a long crystallization time, at temperatures below 100° C. Data stability may be specified e.g. at a temperature of e.g. 50° C. or 30° C. During archival storage of the optical data storage medium, written amorphous marks recrystallize at a certain rate, which is determined by the properties of the recording layer. When marks are recrystallized they cannot be distinghuised anymore from the crystalline surrounding, in other words: the mark is erased. For practical purposes a recrystallization time of at least 20 years at room temperature, i.e. 30° C., is needed.

In United States patent U.S. Pat. No. 6,108,295 the medium of the phase-change type comprises a disk-shaped substrate having thereon a first dielectric layer, a recording layer of the phase-change type, a second dielectric layer and a reflective layer. Such a stack of layers can be referred to as an IPIM-structure, wherein I represents a dielectric layer, P represents a phase-change recording layer and M a metal reflective layer. Said patent discloses a recording layer of the composition M_{y}(SbₓTe₁₋ₓ)_{1-y}, in which formula M is at least one member selected from a large group of elements and 0≦y≦0.3 and 0.5<x<0.9. Specific members exemplified are Ge, In, Ag, Zn. A relatively low recording velocity up to 6 times CD speed, i.e 8.4 m/s, is mentioned but the main objective of this patent is an improved direct overwriting durability, i.e. a large number of DOW cycles without deterioration of the signal quality. Such a velocity requires a CET lower than 100 ns.

It is an object of the invention to provide an optical data storage medium of the kind described in the opening paragraph, which is suitable for high data rate optical recording using direct overwrite, at a linear velocity of more than 16 m/s.

This object is achieved in accordance with the invention by an optical data storage medium of the kind described in the opening paragraph, which is characterized in that the alloy additionally contains 2-10 at. % of Ga.

The present applicant has had the insight that Ga doping, i.e. the addition of Ga to Sb—Te compositions, achieves a significantly faster crystallization speed than other elements like In, Ge and Ag. Ag, Ge and In are known as additions to eutectic or quasi-eutectic Sb—Te phase-compositions from U.S. Pat. No. 6,108,295. The addition of Ga is not specifically exemplified nor special advantages are mentioned. The applicant has also found that, compared with Ge-doped samples, Ga-doped compositions lead to less disk noise at the same recording speed, e.g. 24 m/s. When the alloy contains 3-7 at. % of Ga an additional advantage is achieved in that the archival life stability and media noise is improved. The noise originates from reflection variations in the crystalline phase, and therefore an indication of the media noise may be obtained from the standard deviation (dR) of multiple optical reflection measurements (R) of initialized portions of the disk using an experimental static tester. The variations can be expressed as dR/R.

In an embodiment the alloy furthermore contains 0.5-4.0 at. %, preferably 0.5-2.5 at. % of Ge. For enhanced archival life stability, the Ga-doped Sb—Te material may be co-doped with an ion that forms strong bonds, like Ge. Only a few percents is necessary, i.e. 0.5-2.5%, as too much of this co-doping also negatively influences crystallization rate and noise.

In a further embodiment the atomic Sb/Te ratio is between 3 and 10. The Sb/Te ratio (3-10) can be used to tune the crystallization speed. Higher Sb/Te ratio gives higher crystallization rate. Preferably the atomic Sb/Te ratio is between 3 and 6. Doped compositions at these Sb/Te ratios show less media noise, which is an advantage for high-speed recording. Increasing the crystallization rate by increasing the Sb/Te ratio leads to higher media noise. Therefore it is advantageous to dope the relatively low Sb/Te ratio Sb—Te composition with a “fast” ion like Ga. In this way a high recording speed or data rate may be achieved at a low media noise level.

In a further embodiment a metal reflective layer is present adjacent the second dielectric layer at a side remote from the first dielectric layer. The metal reflective layer may serve to increase the total reflection of the stack and/or the optical contrast. Furthermore it serves as a heat sink in order to increase the cooling rate of the recording layer during the formation of amorphous marks by which re-crystallization during amorphous mark formation is counteracted. The metal reflective may comprise at least one of the metals selected from a group consisting of Al, Ti, Au, Ag, Cu, Pt, Pd, Ni, Cr, Mo, W and Ta, including alloys of these metals. It is preferred that an additional layer is present sandwiched between the metal reflective layer and the second dielectric layer screening the metal reflective layer from a chemical influence of the second dielectric layer. Especially when Ag is used in the reflective layer the possibility of e.g. S atoms of a dielectric layer reacting with the Ag should be prevented. A suitable additional layer for screening comprises e.g. Si₃N₄.

Preferably, the recording layer has a thickness smaller than 20 nm. This has the advantage that the recording layer may have a relatively high optical transmission, which is advantageous in case of multi-stack optical media. In a multi-stack optical medium several recording layers are present. The recording/reading laser beam usually is directed through a “higher level” recording layer in order to record/read into/from a “lower level” recording layer in which case the higher level recording layer must be at least partially transparent for the laser beam in order to pass to the “lower level” recording layer.

The cyclability of the medium may be further increased when the recording layer is in contact with at least one additional carbide layer, having a thickness between 2 and 8 nm. Cyclability is the number of possible DOW cycles before a certain increase in jitter level of the marks written in the medium is reached. Jitter is a measure for the positioning accuracy of the edges of the marks, e.g. in tangential direction. Higher jitter corresponds to lower positioning accuracy. The above materials are used in a stack II⁺PI⁺I or II⁺PI, where I⁺ is a carbide. Alternatively a nitride or an oxide may be used. In the II⁺PI⁺I stack the recording layer P is sandwiched between a first and a second carbide layer I⁺. The carbide of the first and the second carbide layer is preferably a member of the group SiC, ZrC, TaC, TiC, and WC, which combine an excellent cyclability with a short CET. SiC is a preferred material because of its optical, mechanical and thermal properties; moreover, its price is relatively low. The thickness of the additional carbide layer is preferably between 2 and 8 nm. The relatively high thermal conductivity of the carbide will only have a small effect on the stack when this thickness is small, thereby facilitating the thermal design of the stack. A carbide layer between the first dielectric layer and the recording layer does not or hardly influence the optical contrast because of its relatively low thickness.

The second dielectric layer, i.e. the layer between the metal reflective layer and the phase-change recording layer, protects the recording layer from the direct influence of e.g. the metal reflective layer and/or further layers, and optimizes optical contrast and thermal behavior. For optimal optical contrast and thermal behavior the thickness of the second dielectric layer is preferably in the range of 10-30 nm. In view of the optical contrast, the thickness of this layer may alternatively be chosen to be λ/(2 n) nm thicker, wherein λ is the wavelength of the laser-light beam in nm, and n is the refractive index of the second dielectric layer. However, choosing a higher thickness will reduce the cooling influence of the metal reflective or further layers on the recording layer.

An optimum thickness range for the first dielectric layer, i.e. the layer through which the radiation beam, e.g. laser-light beam, enters first, is determined by a.o. the laser-light beam wavelength λ. When λ=670 nm an optimum is found around 90 nm.

The first and second dielectric layers may be made of a mixture of ZnS and SiO₂, e.g. (ZnS)₈₀(SiO₂)₂₀. Alternatives are, e.g. SiO₂, TiO₂, ZnS, AlN, Si₃N₄ and Ta₂O₅. Preferably, a carbide is used, like SiC, WC, TaC, ZrC or TiC. These materials give a higher crystallization speed and better cyclability than a ZnS—SiO₂ mixture.

Both the reflective layers and the dielectric layers may be provided by vapor deposition or sputtering.

The substrate of the optical data storage medium consists, for example, of polycarbonate (PC), polymethyl methacrylate (PMMA), amorphous polyolefin or glass. In a typical example, the substrate is disk-shaped and has a diameter of 120 mm and a thickness of e.g. 0.6 or 1.2 mm. When a substrate of 0.6 or 1.2 mm is used, the layers can be applied on this substrate starting with the first dielectric layer. If the laser-light enters the stack via the substrate, said substrate must be at least transparent to the laser-light wavelength. The layers of the stack on the substrate may also be applied in the reversed order, i.e. starting with the second dielectric layer or metal reflective layer, in which case the laser-light beam will not enter the stack through the substrate. Optionally an outermost transparent layer may be present on the stack as a cover layer that protects the underlying layers from the environment. This layer may consist of one of the above mentioned substrate materials or of a transparent resin, for example, an UV light-cured poly(meth)acrylate with, for example, a thickness of 100 μm. Such a relatively thin cover layer allows a high numerical aperture (NA) of the focused laser-light beam, e.g. NA=0.85 and must be of relatively good optical quality and homogeneous. A thin 100 μm cover layer is e.g. used for the DVR or BD disk. If the laser-light beam enters the stack via the entrance face of this transparent layer, the substrate may be opaque.

The surface of the substrate of the optical data storage medium on the side of the recording layer is, preferably, provided with a servotrack that may be scanned optically with the laser-light beam. This servotrack is often constituted by a spiral-shaped groove and is formed in the substrate by means of a mould during injection molding or pressing. This groove may alternatively be formed in a replication process in a synthetic resin layer, for example, of an UV light-cured layer of acrylate, which is separately provided on the substrate. In high-density recording such a groove has a pitch e.g. of 0.5-0.8 μm and a width of about half the pitch.

High-density recording and erasing can be achieved by using a short-wavelength laser, e.g. with a wavelength of 670 nm or shorter (red to blue).

The phase-change recording layer can be applied to the substrate by vapor depositing or sputtering of a suitable target. The layer thus deposited is amorphous. In order to constitute a suitable recording layer this layer must first be completely crystallized, which is commonly referred to as initialization. For this purpose, the recording layer can be heated in a furnace to a temperature above the crystallization temperature of the Ga doped Sb—Te alloy, e.g. 180° C. A synthetic resin substrate, such as polycarbonate, can alternatively be heated by a laser-light beam of sufficient power. This can be realized, e.g. in a special recorder, in which case the laser-light beam scans the moving recording layer. Such a recorder is also called initializer. The amorphous layer is then locally heated to the temperature required for crystallizing the layer; while preventing that the substrate is being subjected to a disadvantageous heat load.

The invention will be elucidated in greater detail by means of exemplary embodiments and with reference to the accompanying drawings, in which

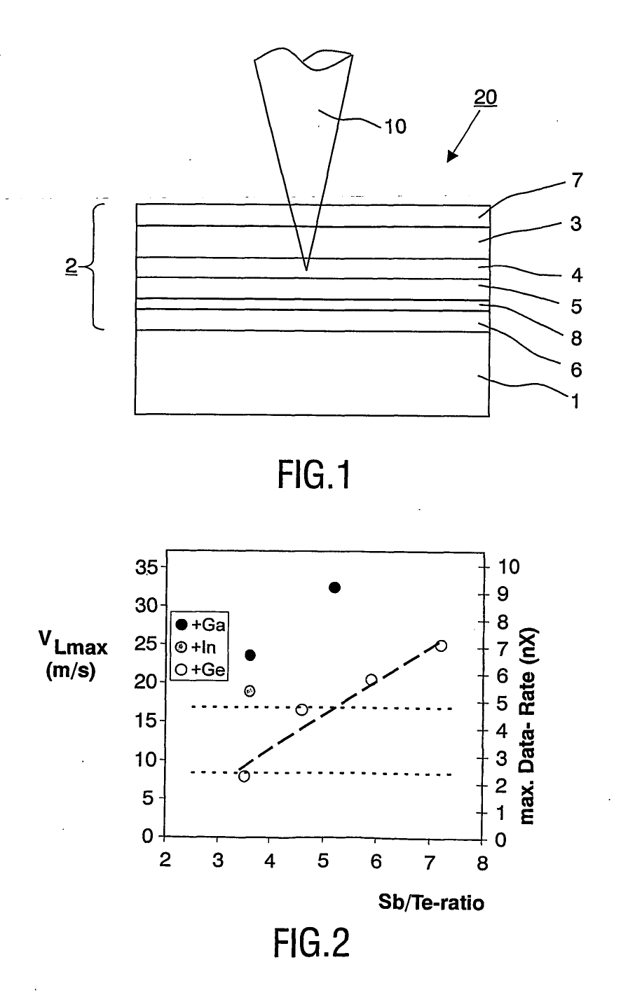

FIG. 1 shows a schematic cross-sectional view of an optical data storage medium in accordance with the invention,

FIG. 2 shows a graphical representation of the maximum linear recording velocity V_{Lmax} for different dopants in an Sb—Te alloy while the Sb/Te ratio is varied.

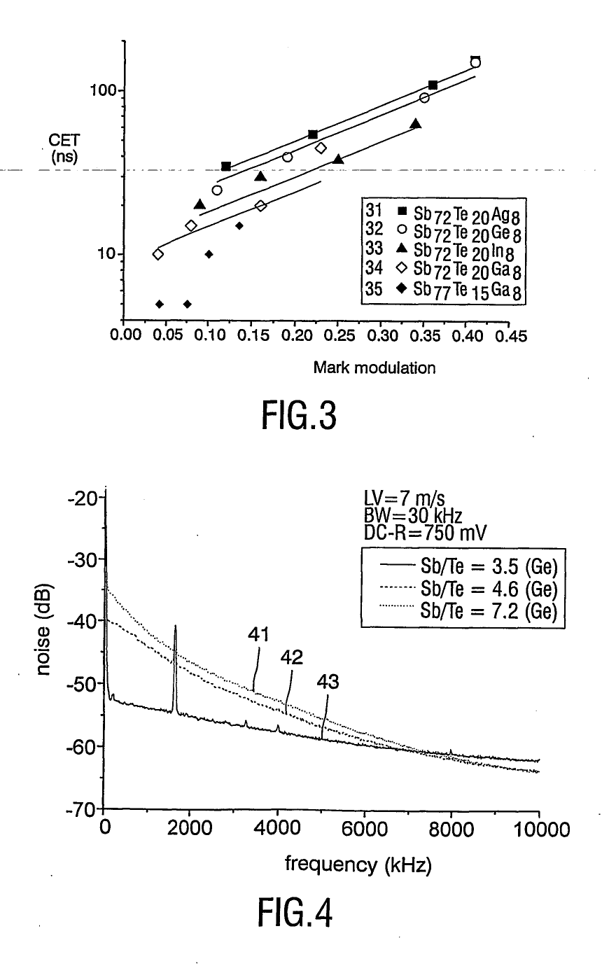

FIG. 3 shows the complete erasure time (CET) as a function of the mark modulation for doped Sb—Te phase-change materials.

FIG. 4 shows noise spectra for Ge-doped Sb—Te compositions measured on a DVD+RW recorder.

In FIG. 1 the rewritable optical data storage medium 20, e.g. a DVR-red disk, for high-speed recording by means of a focused radiation beam 10, has a substrate 1 and a stack 2 of layers provided thereon. The stack 2 has a first dielectric layer 3, made of (ZnS)₈₀(SiO₂)₂₀ having a thickness of 90 nm, a second dielectric layer 5, made of (ZnS)₈₀(SiO₂)₂₀ having a thickness of 22 nm, and a recording layer 4 made of a phase-change material of the alloy with a composition as indicated in tables 1 or 2 examples A1, A2, B and C. The recording layer 4 has a thickness of 14 nm and is interposed between the first dielectric layer 3 and the second dielectric layer 5. A metal reflective layer 6, made of Ag and having a thickness of 120 nm is present adjacent the second dielectric layer 5 at a side remote from the first dielectric layer 3. An additional layer 8 is present sandwiched between the metal reflective layer 6 and the second dielectric layer 5 screening the metal reflective layer 6 from a chemical influence of the second dielectric layer. The additional layer comprises Si₃N₄ and has a thickness of 3 nm.

The amount of dopants is indicated in table 1 or 2. Further, table 1 contains the values of the measured experimental data CET, dR/R. Table 2, inter alia, contains data on the archival life stability. The CET is measured by erasing a matrix of 16×16 amorphous marks with laser pulses, having a wavelength of 670 nm, of a varying power level and time duration. The minimal time required to erase a mark is the CET. An indication of media noise is obtained from dR/R as was described earlier. The archival life is extrapolated. The extrapolation curve is based on the generally accepted assumption that the crystallization time is exponentially dependent on the inverse absolute temperature (in K). The crystallization behavior is measured on written marks. Normally the stability is based on the as deposited amorphous state, which however generally leads to a too high value of the stability. This is because the written amorphous marks contain many more nucleation sites, especially at the crystalline mark edges leading to crystallite growth, than the as deposited amorphous state layer, which increases the crystallization speed. For the written mark crystallization behavior measurements, e.g. CET, the following procedure was used. Stacks were sputtered on glass substrates and the flat parts of the disks were initialized with a laser. DVD density carriers were written continuously in a spiral manner in the initialized parts. Pieces cut from the disk were placed in a furnace and the amorphous marks were subsequently crystallized at a specific temperature while monitoring the reflection with a large laser spot (λ=670 nm).

A protective layer 7, made e.g. of a laser-light transparent UV curable resin having a thickness of 100 μm is present adjacent the first dielectric layer 3. Spincoating and subsequent UV curing may provide layer 7.

Sputtering provides the layers 3, 4, 5, 6 and 8. The initial crystalline state of the recording layer 4 is obtained by heating the as-deposited amorphous recording layer 4 in an initializer by means of a continuous laser-light beam to above its crystallization temperature.

Table 1 summarizes the results of examples, wherein the level of doping of the Sb—Te alloy has been varied using a single dopant. A1 is an example with the dopant Ga according to the invention, while D, E and F are examples with the known dopants In, Ge and Ag. Note that the CET of A1 is significantly lower than the CET of sample D, E and F.

### TABLE 1 EXAMPLES A1, D, E and F

TABLE 1

| | | | Atomic | | |
|---|---|---|---|---|---|
| | Dopant 1 | Dopant 2 | Sb/Te | CET | dR/R |
| Example | (at. %) | (at. %) | ratio | (ns) | (%) |
| A1 | Ga (8) | — | 3.6 | 19 | 1.4 |
| D | In (8) | — | 3.6 | 29 | 1.1 |
| E | Ge (8) | — | 3.6 | 33 | 1.1 |
| F | Ag (8) | — | 3.6 | 41 | 0.9 |

### TABLE 2 EXAMPLES A2, B and C

In the examples B and C of table 2 the effect is shown when the Sb—Te alloy doped with Ga furthermore contains 1 respectively 2 at. % of Ge (Dopant 2). The amount of Ga is decreased accordingly. It can be seen that the extrapolated archival life at 30° C. is significantly improved by adding Ge. Adding more than 2.5% Ge will lead to an increase of the CET (not shown in table).

TABLE 2

| | | | Atomic | | Extrapolated | |
|---|---|---|---|---|---|---|
| | Dopant 1 | Dopant 2 | Sb/Te | dR/R | Archival life at | |
| Example | (at. %) | (at. %) | ratio | (%) | 30° C. | |
| A2 | Ga (5) | | 3.3 | 0.6 | 20-25 | years |
| B | Ga (4) | Ge (1) | 3.3 | 0.5 | 7240 | years |
| C | Ga (3) | Ge (2) | 3.3 | 0.7 | 5 * 10⁵ | years |

FIG. 2 shows the expected maximum data rate for the DVD+RW format (1X=11 Mbit/s) and maximum linear disk velocity for Ga, In and Ge-doped Sb—Te compositions. The Sb/Te ratio can be used as a parameter to control the maximum linear media velocity, which is in first approximation inversely proportional to the CET, (shown for Ge-doped compositions). The linear media velocity (left vertical axis) can be directly translated to a data rate (right vertical axis). At a Sb/Te ratio of approximately 3.5, Ga-doping gives the highest data rate. An even higher speed or data rate, i.e. V_{Lmax} of 32 m/s, is achieved at a Sb/Te ratio of 5.2 with Ga doping.

FIG. 3 shows CET measurements for different compositions as a function of the mark modulation. The mark modulation is a measure for the mark size of an amorphous mark. The larger the modulation the larger the mark diameter. For growth dominated crystallization processes the CET is directly proportional to the mark diameter. This can be understood because the amorphous mark recrystallization starts at the edge, and therefore the smaller the mark diameter the faster it is fully recrystallized. Points 31, 32 and 33 show CET results for respectively Ag, Ge and In doped “eutectic” Sb—Te. “Eutectic” refers to compositions at or relatively close to the eutectic composition Sb₆₉Te₃₁. Points 34 and 35 represent the results for Ga doped Sb—Te for a Sb/Te ratio of 3.6 and 5.1 respectively. It can be seen that the latter shows extremely fast crystallization. This extremely fast crystallization property may lead to small marks due to re-crystallization of the mark during writing. Applying a heat sink, e.g. a reflective metal layer, adjacent the recording layer can counteract this re-crystallization.

FIG. 4 shows three media noise spectra for a Ge doped Sb—Te alloy at different Sb/Te ratios. The linear media velocity is 7 m/s, the detector DC level of reflection is 750 mV and the measuring bandwidth is 30 kHz. Increasing the Sb/Te ratio leads to a higher crystallization rate. However, from FIG. 4 it can be observed that media noise increases with Sb/Te ratio. Graph 43 represents a Ge doped Sb—Te alloy with a Sb/Te ratio of 3.5 and shows low media noise. However this alloy has a relatively high CET or low data rate/speed. Therefore, it is advantageous to use a “fast” dopant like Ga, so that a smaller Sb/Te ratio can be chosen and low media noise is obtained, as seen in table 1. Stacks made with Ge-doped compositions with a Sb/Te ratio of 4.6 (graph 42) and 7.2 (graph 41) have too much media noise and therefore are less suitable.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a rewritable optical data storage medium for high-speed recording by means of a focused radiation beam is described. The medium comprises a substrate carrying a stack of layers. The stack comprises, a first dielectric layer, a second dielectric layer, and a recording layer of a phase-change material of an alloy comprising Sb and Te. The recording layer is interposed between the first dielectric layer and the second dielectric layer. The alloy additionally contains 2-10 at. % of Ga, by which a significant improvement of the maximum data rate during direct overwrite is achieved. By furthermore adding 0.5-4.0% of Ge to the alloy the archival life stability is enhanced.

1. A rewritable optical data storage medium (20) for high-speed recording by means of a focused radiation beam (10), said medium (20) comprising a substrate (1) carrying a stack (2) of layers, which stack (2) comprises, a first dielectric layer (3), a second dielectric layer (5), and a recording layer (4) of a phase-change material of an alloy comprising Sb and Te, the recording layer (4) being interposed between the first dielectric layer (3) and the second dielectric layer (5), characterized in that the alloy additionally contains 2-10 at. % of Ga.

2. An optical data storage medium (20) as claimed in claim 1, wherein the alloy contains 3-7 at. % of Ga.

3. An optical data storage medium (20) as claimed in claim 1, wherein the alloy furthermore contains 0.5-4.0 at. %, preferably 0.5-2.5 at. % of Ge.

4. An optical data storage medium (20) as claimed in claim 1, wherein the atomic Sb/Te ratio is between 3 and 10.

5. An optical data storage medium (20) as claimed in claim 4, wherein the atomic Sb/Te ratio is between 3 and 6.

6. An optical data storage medium (20) as claimed in claim 1, wherein a metal reflective layer (6) is present adjacent the second dielectric layer (5) at a side remote from the first dielectric layer (3).

7. An optical data storage medium (20) as claimed in claim 6, wherein an additional layer (8) is present sandwiched between the metal reflective layer (6) and the second dielectric layer (5) screening the metal reflective layer (6) from a chemical influence of the second dielectric layer (5).

8. An optical data storage medium as claimed in claim 7, wherein the additional layer (8) comprises Si₃N₄.
